(19) United States
(12) Patent Application Publication
(10) Pub. No.: US 2005/0240343 A1
(43) Pub. Date: Oct. 27, 2005

(54) Portable wireless device utilization for telematics purposes

(76) Inventors: Peter E. Schmidt II, Saginaw, MI (US); Paul Olszewski, Clio, MI (US)

Correspondence Address: STEPHEN R. LOE, THE LAW OFFICE OF STEPHEN R. LOE, P.O. BOX 649, FRISCO, TX, 75034, US

(21) Appl. No.: 10/831,019

(22) Filed: Apr. 23, 2004

(51) Int. Cl. G05D 1/00

(52) U.S. Cl. 701/210; 340/988; 701/1

(57) ABSTRACT

A method, system, computer program product, and device for providing telematic services to a vehicle utilizing an external portable wireless device such as, for example, a wireless mobile phone, is provided. In one embodiment, the telematics device collects vehicle data from the vehicle and, responsive to a determination that a portable wireless device is not coupled to a telematic unit, buffers the vehicle data in a memory until such time as a portable wireless device is coupled to the telematic unit. Once the user's portable wireless device is coupled to the telematic unit, the telematic unit transmits the vehicle data from the telematic unit to the user's portable wireless device which then sends the vehicle data to a telematics service provider.

### BACKGROUND OF THE INVENTION

1. Technical Field

The present invention relates generally to computer software and wireless communications and, more particularly to telematic systems for vehicles.

2. Description of Related Art

Originally, the term telematics referred to the blending of computers and wireless telecommunications technologies, ostensibly with the goal of efficiently conveying information over vast networks to improve a host of business functions or government-related public services. However, the term has evolved to refer to automobile systems that combine global positioning satellite (GPS) tracking and other wireless communications for automatic roadside assistance and remote diagnostics. General Motors Corp. first popularized automotive telematics with its OnStar system which is now provided by OnStar, Inc. which is a subsidiary of General Motors Corp.

Currently, major automakers are equipping new prototype vehicles with wireless-based services controlled by voice commands. This kind of telematics could enable motorists to perform a variety of wireless functions such as accessing the Internet, receiving or sending e-mail, downloading digital audio and video files, or obtaining “smart” transportation information. Some telematic systems, such as, for example, OnStar are Original Equipment Manufacturer (OEM) systems. Other telematic systems may be aftermarket systems, such as, for example, those available from Delphi Corporation of Troy, Mich. However all of these telematic functions, including both OEM and after market telematics, suffer from a common flaw. All of these telematic systems are proprietary in nature. This means that a user has to have proprietary equipment installed into the vehicle that only works with a particular proprietor's telematic service. Thus, in order to change telematic service providers, a user must install new equipment.

This can become very expensive as well as burdensome upon a user. Thus, user choice is limited and the price a user pays for telematic services is increased. Therefore, it would be desirable to have a telematics unit that is independent of the particular telematic service provider which allows a user to switch between providers at will without the necessity of installing new equipment.

### SUMMARY OF THE INVENTION

The present invention provides a method, system, computer program product, and device for providing telematic services to a vehicle utilizing an external portable wireless device such as, for example, a wireless mobile phone. In one embodiment, the telematics device collects vehicle data from the vehicle and, responsive to a determination that a portable wireless device is now coupled to a telematic unit, buffers the vehicle data in a memory until such time as a portable wireless device is coupled to the telematic unit. Once the user's portable wireless device is coupled to the telematic unit, the telematic unit transmits the vehicle data from the telematic unit to the user's portable wireless device which then sends the vehicle data to a telematics service provider.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a system diagram illustrating a distributed data processing system in which the present invention may be implemented;

FIG. 2, a pictorial diagram of an exemplary telematics service provider is depicted in accordance with one embodiment of the present;

FIG. 3 depicts a block diagram of a wireless device (WD), such as, for example, a wireless telephone or a wireless personal digital assistant (PDA), in accordance with the present invention;

FIG. 4A depicts a pictorial diagram of a wireless device telematics system in accordance with one embodiment of the present invention;

FIG. 4B depicts a block diagram of a telematics system in accordance with the present invention;

FIG. 5 depicts a flowchart illustrating the functioning of a prior art telematics system in order to contrast it with the telematics system of the present invention;

FIG. 6 depicts a flowchart illustrating the use of a portable wireless device for transmission of data for telematics purposes in accordance with one embodiment of the present invention; and

FIG. 7 depicts a flowchart illustrating an exemplary process for receiving data from a telematic service provider in accordance with one embodiment of the present invention.

### DETAILED DESCRIPTION OF THE PREFERRED EMBODIMENT

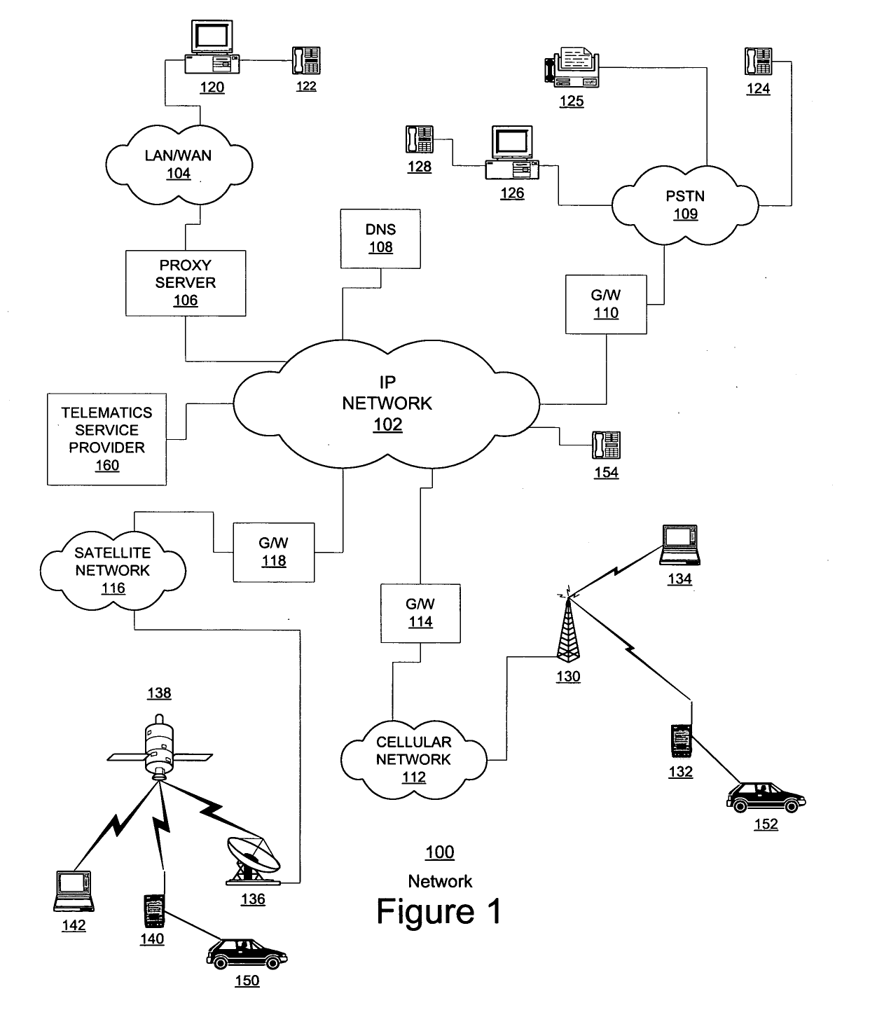

With reference now to the figures, and in particular with reference to FIG. 1, a system diagram illustrating a distributed data processing system in which the present invention may be implemented is depicted.

Distributed data processing system 100 is a plurality of interconnected heterogeneous networks in which the portable wireless device utilization for telematics purposes of the present invention may be implemented. Telematics, as used herein, refers generally to automobile systems that combine global positioning satellite (GPS) tracking and other wireless communications for automatic roadside assistance and remote diagnostics purposes.

As illustrated, distributed data processing system 100 contains an Internet Protocol (IP) network 102, a Local Area Network (LAN)/Wide Area Network (WAN) 104, the Public Switched Telephone Network (PSTN) 109, a cellular wireless network 112, and a satellite communication network 116. Networks 102, 104, 109, 112, and 116 may include permanent connections, such as wire or fiber optic cables, or temporary connections made through telephone connections.

IP network 102 may be the publicly available IP network (the Internet), a private IP network, or a combination of public and private IP networks. In any case, IP network 102 operates according to the Internet Protocol and routes packets among its many switches and through its many transmission paths. IP networks are generally known in the art to be expandable, fairly easy to use and heavily supported. Coupled to IP network 102 is a Domain Name Server (DNS) 108 to which queries may be sent, such queries each requesting an IP address based upon a Uniform Resource Locator (URL). IP network 102 supports 32 bit IP addresses as well as 128 bit IP addresses, which are currently in the planning stage.

LAN/WAN 104 couples to IP network 102 via a proxy server 106 (or another connection). LAN/WAN 104 may operate according to various communication protocols, such as the Internet Protocol, the Asynchronous Transfer Mode (ATM) protocol, or other known packet switched protocols. Proxy server 106 serves to route data between IP network 102 and LAN/WAN 104. A firewall that precludes unwanted communications from entering LAN/WAN 104 may also be located at the location of proxy server 106.

Computer 120 couples to LAN/WAN 104 and supports communications with LAN/WAN 104. Computer 120 may employ the LAN/WAN and proxy server 106 to communicate with other devices across IP network 102. Such communications are generally known in the art and will not be further described herein except to expand upon the teachings of the present invention. As is also shown, phone 122 couples to computer 120 and may be employed to initiate IP Telephony communications with another phone or voice terminal using IP Telephony. In such an IP telephony system, a gatekeeper 152 is deployed by a service provider to manage IP telephony for its users. An IP phone 154 connected to IP network 102 (or other phone, e.g., phone 124) may communicate with phone 122 using IP telephony.

PSTN 109 is a circuit switched network that is primarily employed for voice communications, such as those enabled by a standard phone 124. However, PSTN 109 also supports the transmission of data. Data transmissions may be supported to a tone based terminal, such as a FAX machine 125, to a tone based modem contained in computer 126, or to another device that couples to PSTN 109 via a digital connection, such as an Integrated Services Digital Network (ISDN) line, an Asynchronous Digital Subscriber Line (ADSL), or another digital connection to a terminal that supports such a connection. As illustrated, a voice terminal, such as phone 128, may couple to PSTN 109 via computer 126 rather than being supported directly by PSTN 109, as is the case with phone 124. Thus, computer 126 may support IP telephony with voice terminal 128, for example.

Cellular network 112 supports wireless communications with terminals operating in its service area (which may cover a city, county, state, country, etc.). As is known, cellular network 112 includes a plurality of towers, e.g., 130, that each service communications within a respective cell. Wireless terminals that may operate in conjunction with cellular network 112 include wireless handsets 132 and wirelessly enabled laptop computers 134, for example. Wireless handsets 132 could be, for example, personal digital assistants, wireless or cellular telephones, or two-way pagers. Cellular network 112 couples to IP network 102 via gateway 114.

Wireless handsets 132 and wirelessly enabled laptop computers 134 may communicate with cellular network 112 using, for example, a wireless application protocol (WAP). It should be noted, however, that the present invention is not limited to use with WAP, but, as those skilled in the art will recognize, may use other protocols as well. WAP is an open, global specification that allows mobile users with wireless devices, such as, for example, mobile phones, pagers, two-way radios, smartphones, communicators, personal digital assistants, and portable laptop computers, to easily access and interact with information and services almost instantly. WAP is a communications protocol and application environment and can be built on any operating system including, for example, Palm OS, EPOC, Windows CE, FLEXOS, OS/9, and JavaOS. WAP provides interoperability even between different device families.

WAP is the wireless equivalent of Hypertext Transfer Protocol (HTTP) and Hypertext Markup Language (HTML). The HTTP-like component defines the communication protocol between the handheld device and a server or gateway. This component addresses characteristics that are unique to wireless devices, such as data rate and round-trip response time. The HTML-like component, Wireless Markup Language (WML), defines new markup and scripting languages for displaying information to and interacting with the user. This component is highly focused on the limited display size and limited input devices available on small, handheld devices. For example, a typical cell phone may have only a 4 line×10-character display with 16-gray levels and only a numeric keypad plus up/down volume keys.

Communicatively coupled to wireless handset 140 is automobile 150. Automobile 150 transmits data, either via a wire(s) or wirelessly (e.g., infrared transmission or Bluetooth transmission), to handset 140. This data may include, for example, information about the location of the automobile 150, perhaps obtained from a GPS device within the automobile 150, information about the performance of various components within automobile 150, or information received from a user. The wireless handset 140 then retransmits the telematics data to telematics service provider 160 via IP network 102. Telematics service provider 160 then processes the data and sends appropriate data, such as, for example, driving directions or voice data from a telematics service provider 160 service person, back to automobile 150 via handset 140. Telematics service provider 160 may also contact other services on behalf of the service subscriber in automobile 150. Contacting other services may include, for example, contacting emergency personal or making dinner reservations.

Cellular network 112 operates according to an operating standard, which may be the Advanced Mobile Phone System (AMPS) standard, the Code Division Multiple Access (CDMA) standard, the Time Division Multiple Access (TDMA) standard, or the Global System for Mobile Communications or Groupe Speciale Mobile (GSM), for example. Independent of the standard(s) supported by cellular network 112, cellular network 112 supports voice and data communications with terminal units, e.g., 132 and 134.

Satellite network 116 includes at least one satellite dish 136 that operates in conjunction with a satellite 138 to provide satellite communications with a plurality of terminals, e.g., laptop computer 142 and satellite handset 140. Satellite handset 140 could also be a two-way pager. Satellite network 116 may be serviced by one or more geosynchronous orbiting satellites, a plurality of medium earth orbit satellites, or a plurality of low earth orbit satellites. In any case, satellite network 116 services voice and data communications and couples to IP network 102 via gateway 118.

Automobile 152 is communicatively coupled to wireless handset 132. Again, this may be either wired or wireless coupling. Wireless handset 132 receives data from automobile 152 and retransmits that data to telematics service provider 160 much as wireless handset 140 provided this service for automobile 150. Wireless handset 132 also receives data from telematics service provider 160 and retransmits this data to automobile 152.

FIG. 1 is intended as an example and not as an architectural limitation for the processes of the present invention. For example, distributed data processing system 100 may include additional servers, clients, and other devices not shown.

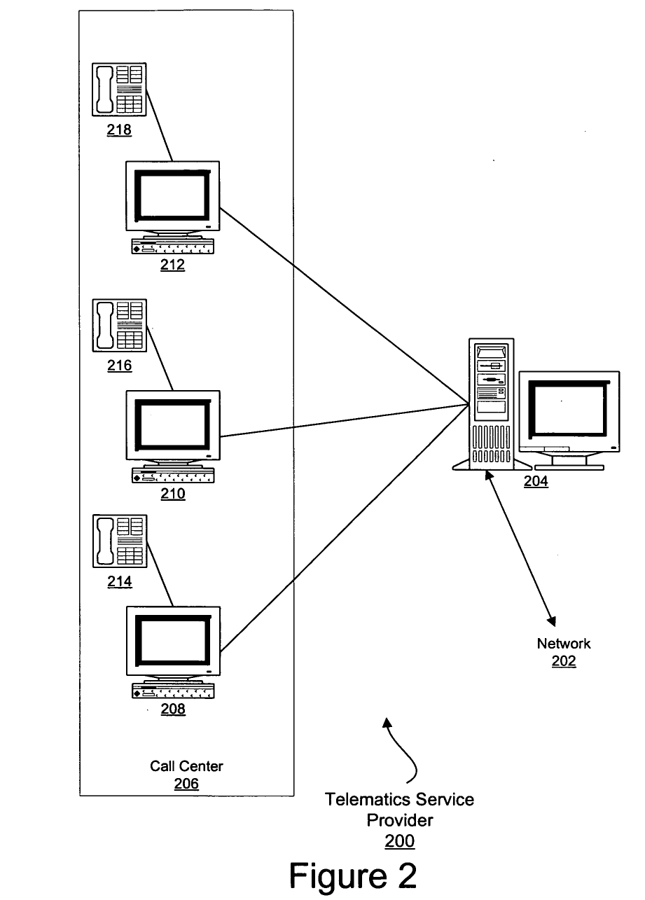

Referring to FIG. 2, a pictorial diagram of an exemplary telematics service provider is depicted in accordance with one embodiment of the present invention. Telematics service provider 200 may be implanted as, for example, telematics service provider 160 depicted in FIG. 1.

Telematics service provider 200 includes a server 204 connected to a network 202, such as, for example, IP network 102 depicted in FIG. 1. Also connected to server 204 is a call center 206 which includes a plurality of workstations 208-212 and telephones 214-218 allowing service operators to receive, monitor, and respond to information received from various automobiles which have subscriptions with the telematics service provider 200.

Server 204 receives information from subscriber automobiles through the network 202. Server 204 processes this data and returns data to the subscriber automobiles as appropriate. Server 204 may recognize that some data requires call center service technician to view the data and/or perform a task. For example, the server 204 may receive data from an automobile indicating that the airbags have deployed, thus requiring a call center service technician to contact the subscriber and/or contact emergency personnel to come to the aid of the subscriber in the automobile. When this is the case, the server 204 routes the appropriate data to a workstation 208-212 within call center 206 thus alerting a call center service technician to view the data and make an appropriate response, including speaking with a person in the corresponding automobile via a telephone 214-218 or other means. The call center service technician may also call other services, such as, for example, an ambulance, police, or fire, and have these other services directed to the subscriber automobile to aid the subscriber. The service technician may also perform other services on behalf of the subscriber, such as, for example, unlocking the doors to the automobile, making dinner reservations, or providing driving directions.

Telematics service provider 200 is provided merely as an example of a telematics service provider and is not intended as an architectural limitation to the present invention. For example, telematics service provider 200 may include other devices not shown as well as provide other services not discussed above.

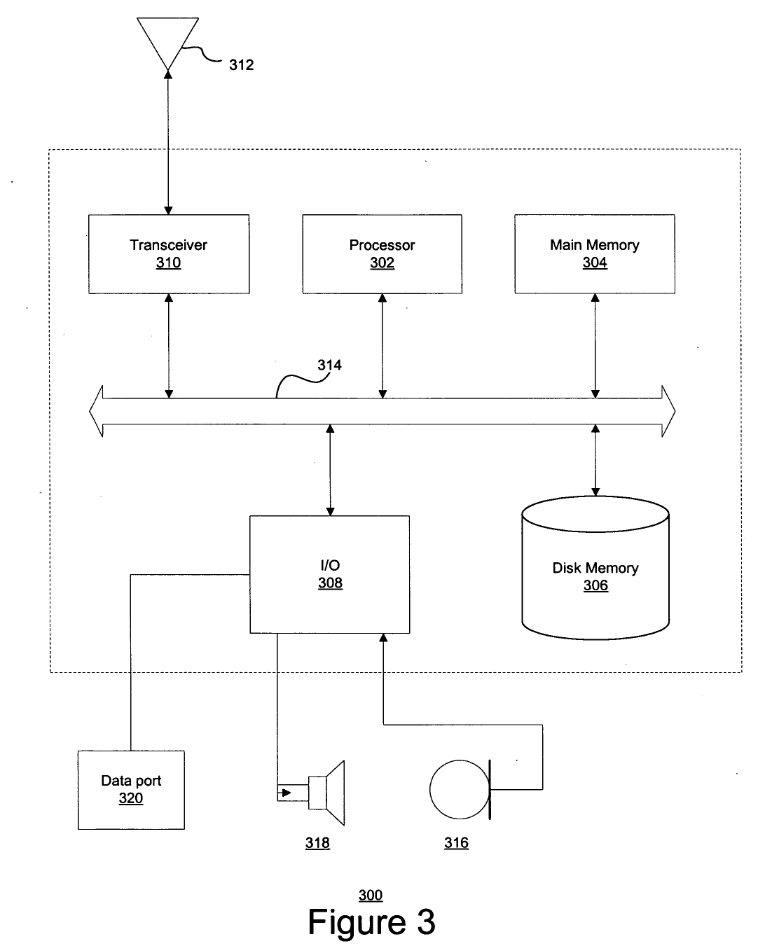

Turning now to FIG. 3, a block diagram of a wireless device (WD), such as, for example, a wireless telephone or a wireless personal digital assistant (PDA) is illustrated in which the present invention may be implemented. WD 300 may be implemented as terminal units 132 and 134 depicted in FIG. 1. WD 300 is a data processing system (i.e., a computer) which is small and portable. If the wireless device is implemented as a PDA, the PDA is typically a palmtop computer, such as, for example, a Treo 600®, a product and registered trademark of PalmOne, Inc. in Milpitas, Calif., which may be connected to a wireless communications network, such as, for example, network 100 depicted in FIG. 1, and which may provide voice, fax, e-mail, and/or other types of communication. The WD 300 may perform other types of facilities to the user as well, such as, for example, provide a calendar and day planner. The WD 300 may have one or more processors 302, such as a microprocessor, a main memory 304, a disk memory 306, and an I/O 308 such as a mouse, keyboard, or pen-type input, and a screen or monitor. The WD 300 also includes a wireless transceiver 310 connected to an antenna 312 configured to transmit and receive wireless communications. The processor 302, memories 304, 306, I/O 308, and transceiver are connected to a bus 304. The bus transfers data, i.e., instructions and information, between each of the devices connected to it. The I/O 308 may permit faxes, e-mail, or optical images to be displayed on a monitor or printed out by a printer. The I/O 308 may be connected to a microphone 316 and a speaker 318 so that voice or sound information may be sent and received. I/O 308 may also be connected to a data port 320 to allow the WD 300 to be coupled to a data source such as that from an onboard diagnostic computer through, for example, a docking station in the automobile, or through a wireless mechanism such as, for example, Bluetooth or an infrared (IR) system. Thus, WD 300 may be used to transmit data to and receive data from a telematics service provider.

Those of ordinary skill in the art will appreciate that the hardware in FIG. 3 may vary depending on the implementation. The depicted example is not meant to imply architectural limitations with respect to the present invention.

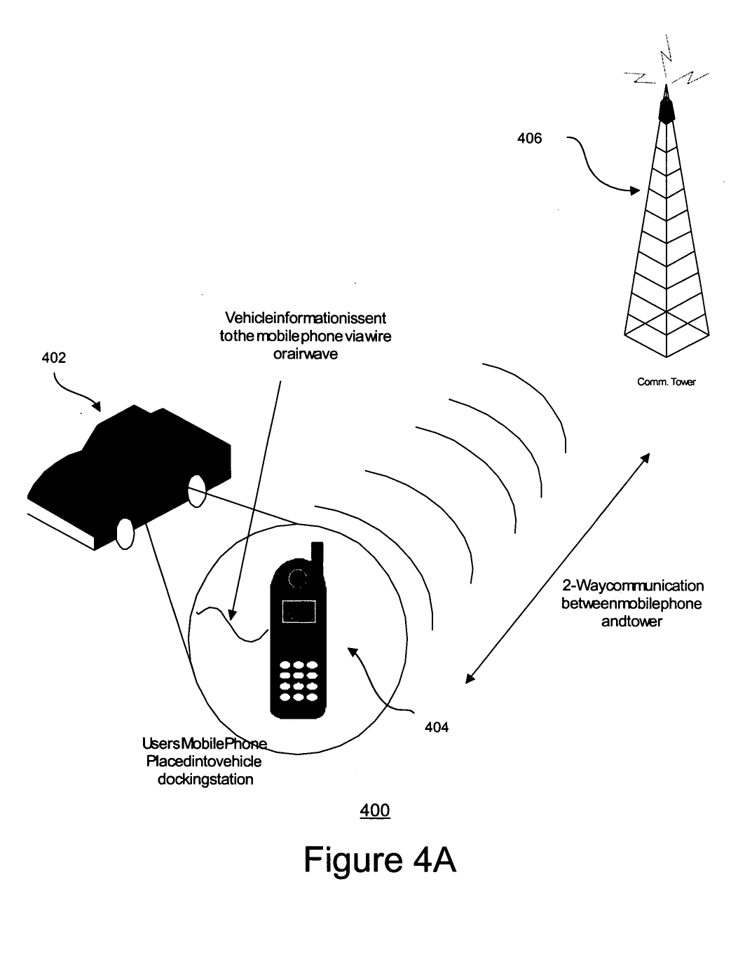

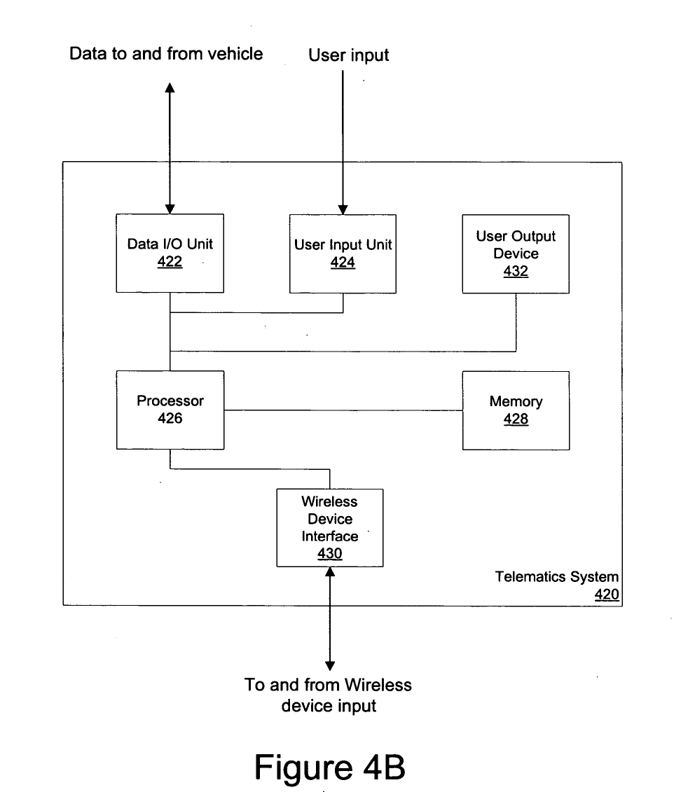

With reference now to FIG. 4A, a pictorial diagram of a wireless device telematics system is depicted in accordance with one embodiment of the present invention. A user places a portable or handheld wireless device 404, such as a mobile phone, into, for example, a vehicle docking station or connects wirelessly, such as, for example via an infrared connection or Bluetooth. Vehicle information is sent from the vehicle's 402 onboard computer to the wireless device 404 via direct wired connection or via airwave. The wireless device 404 provides two way communication between the vehicle 402 and a communication tower 406 connected to a wireless network through which a service provider could provide vehicle and driver assistance. Such assistance could include, but is not limited to, providing emergency services such as alerting and directing emergency personal, such as police, fire, or emergency medical technicians, to assist a motorist, providing directions, unlocking the car, tracking a stolen vehicle, providing roadside assistance, as well as other innumerable services. It should be noted that some of these services may require the use of location determining devices such as global positioning systems (GPS). However, such devices are well known in the art.

Thus rather than having to have a proprietary system, such as, for example, OnStar, a service available from OnStar Corporation of Troy, Mich., installed in their vehicle which, once installed, limits the individual to the use of a single service provider's telematic services, thereby increasing the cost to the user, the user can choose from any number of telematic service providers. This is due to the fact that the wireless device, such as a wireless telephone, could be used to transmit to any telephone number. Thus differing service provider's would have different telephone numbers and individuals could select the provider having a price and service plan that best met the needs of the individual. In fact, existing mobile phone service providers could provide telematic services which could be offered to subscribers as part of the subscriber's mobile phone plan. In such a case, the individual may have only to contract with a single provider to obtain wireless service and telematics service, thereby eliminating extra bills to be paid each month and possibly reducing overall cost.

With reference now to FIG. 4B, a block diagram of a telematics system is depicted in accordance with the present invention. Telematics system 420 may be implemented within a vehicle, such as, for example, vehicle 402 depicted in FIG. 4A. Telematics system 420 includes a data I/O unit 422, a user input unit 424, a user output device 432, a processor 426 (in some embodiments, there may be more than one processor involved), memory 428, and wireless device interface 430.

Data I/O unit 422 provides an interface between telematics system 420 and a vehicle. User input unit 424 provides a mechanism for a user to input data and otherwise communicate with a telematics service provider. User input unit 424 could be, for example, a microphone, a keypad, a pointing device coupled to a display, or a combination of these or other devices. User output device 432 enables the telematics service provider to communicate with the user and may include, for example, a speaker and/or a video display unit. Processor 426 processes data received from the vehicle, user, and telematics service provider and delivers the data to the appropriate entity in the appropriate format. Processor 426 may perform other functions as well. Memory 428 stores data collected by the telematics system 420 until the data is ready to be transmitted to a wireless device. Wireless device interface 422 provides an interface between telematics system 420 and a wireless device thereby allowing telematics system 420 to communicate with a wireless device and ultimately with the telematics service provider.

Those of ordinary skill in the art will appreciate that the hardware in FIG. 4B may vary depending on the implementation. For example, telematics system 420 may also include a Global Positioning System (GPS) unit or other location determining unit. The depicted example is not meant to imply architectural limitations with respect to the present invention.

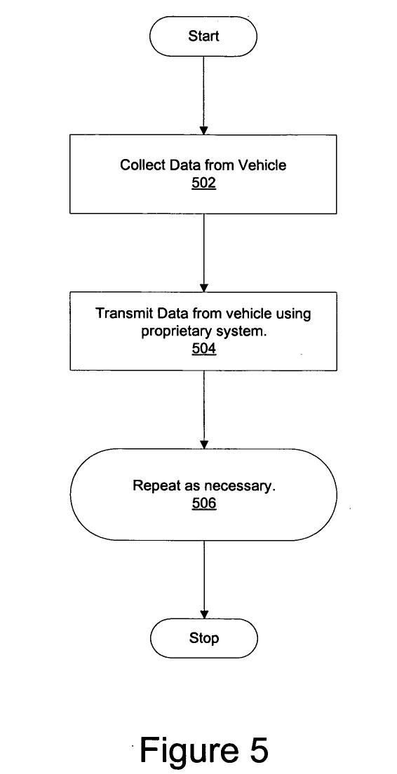

Referring now to FIG. 5, a flowchart illustrating the functioning of a prior art telematics system is depicted in order to contrast it with the telematics system of the present invention. The prior art proprietary telematics system collects data from the vehicle through proprietary hardware and software (step 502). The telematics data is then transmitted from the vehicle to the telematics service provider through the service provider's proprietary system (step 504). These steps are repeated as necessary (step 506).

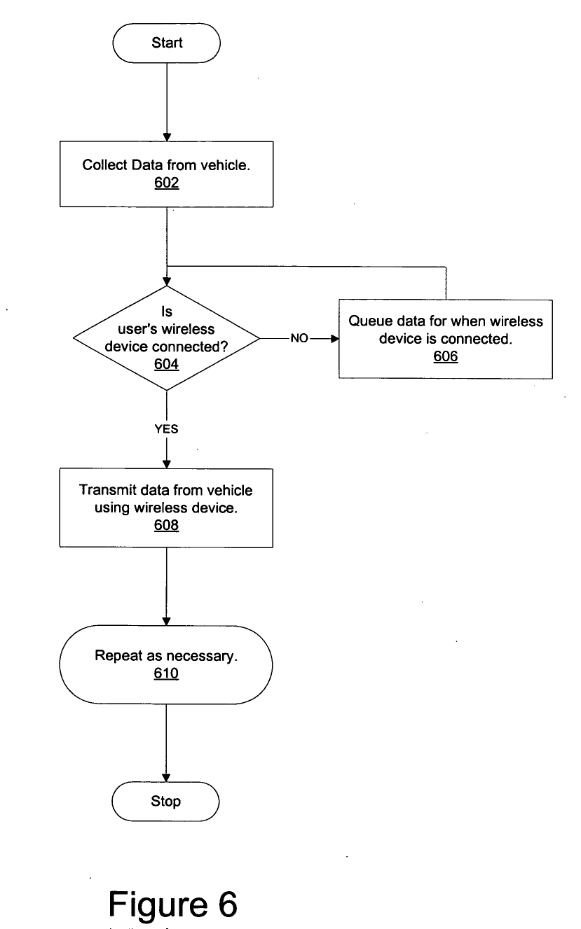

With reference now to FIG. 6, a flowchart illustrating the use of a portable wireless device for transmission of data for telematics purposes is depicted in accordance with one embodiment of the present invention. The telematics system of the present invention collects data from the vehicle in a manner similar to that of the prior art systems (step 602). However, rather than send the data to the service provider utilizing the service provider's proprietary hardware and software, the telematics system determines whether the user's wireless device is connected (either through wires or wirelessly) to the telematics system (step 604). If the user's wireless device is not connected to the telematics system, then the telematics system queues the data for when the wireless device is connected (step 606). If the user's wireless device is connected, then the data is transmitted to the telematics service provider using the user's wireless device (step 608). This process may then be repeated as necessary (step 610).

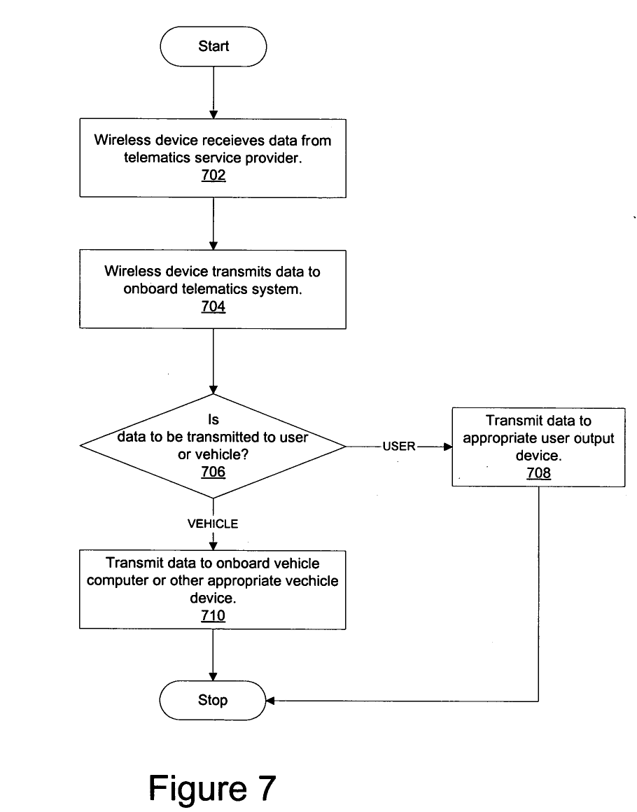

With reference now to FIG. 7, a flowchart illustrating an exemplary process for receiving data from a telematic service provider is depicted in accordance with one embodiment of the present invention. To begin, a wireless device receives data from a telematics service provider (step 702). The wireless device then transmits the data to the onboard telematics system, such as, for example, telematics system 420 depicted in FIG. 4B (step 704). The telematics system then determines whether the data is to be transmitted to the user or the vehicle (step 706). The data is then transmitted and presented to the user through an appropriate user output device (step 708) or is transmitted to an onboard vehicle computer or other appropriate vehicle device (step 710) depending on the type of data the telematics system determined the data to be in step 706.

It will be apparent to those skilled in the art that the only hardware and software that is required to add to a vehicle for the telematics system of the present invention is hardware and software sufficient to collect and transmit appropriate data to and from the vehicle and user, queue the data if necessary, and interface with a portable wireless device. This hardware and software is similar to corresponding hardware and software in prior art systems and is well known to those skilled in the art. The prior art, whether it was an Original Equipment Manufacturer (OEM) built in hardware or an after market installed system, required proprietary or additional automotive hardware necessary to transmit the data. However, in the present invention, additional hardware for this function is not necessary since this function is provided by the user's existing wireless device, thus reducing the amount of hardware that must be added to a vehicle in order to provide a telematics system. Thus, this reduces the expense and complication of the equipment that is necessary for installation of a telematics system below that of the prior art. Furthermore, since the telematics unit is decoupled from the wireless transmission system, the user is not tied to a particular telematics service provider indefinitely as in the prior art since the user may simply switch telematic service providers without installing new equipment.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for providing telematic services for a vehicle, the method comprising:
collecting vehicle data from the vehicle;
responsive to a determination that a portable wireless device is not coupled to a telematic unit, buffering the vehicle data in a memory until such time as a portable wireless device is coupled to the telematic unit; and
responsive to a determination that a user's portable wireless device is coupled to a telematic unit, transmitting the vehicle data from the telematic unit to the user's portable wireless device.

2. The method as recited in claim 1, wherein the portable wireless device comprises one of a wireless telephone, a personal digital assistant, and a portable data processing system.

3. The method as recited in claim 1, further comprising:
transmitting, from the wireless device, the vehicle data received from the telematic unit to a telematic service provider.

4. The method as recited in claim 3, further comprising:
receiving, at the wireless device, service data from the telematic service provider;
transmitting the service data to the telematic unit;
processing the service data at the telematic unit to product processed service data; and
transmitting the processed service data to an appropriate output device.

5. The method as recited in claim 1, wherein collecting data from the vehicle comprises receiving user input.

6. The method as recited in claim 4, wherein the appropriate output device comprises an onboard vehicle computer.

7. The method as recited in claim 4, wherein the appropriate output device comprises a user output device.

8. The method as recited in claim 7, wherein the user output device comprises at least one of a speaker and a video display terminal.

9. A computer program product in a computer readable media for use in a data processing system for providing telematic services for a vehicle, the computer program product comprising:
first instructions for collecting vehicle data from the vehicle;
second instructions, responsive to a determination that a portable wireless device is not coupled to a telematic unit, for buffering the vehicle data in a memory until such time as a portable wireless device is coupled to the telematic unit; and
third instructions, responsive to a determination that a user's portable wireless device is coupled to a telematic unit, for transmitting the vehicle data from the telematic unit to the user's portable wireless device.

10. The computer program product as recited in claim 9, wherein the portable wireless device comprises one of a wireless telephone, a personal digital assistant, and a portable data processing system.

11. The computer program product as recited in claim 9, further comprising:
fourth instructions for transmitting, from the wireless device, the vehicle data received from the telematic unit to a telematic service provider.

12. The computer program product as recited in claim 11, further comprising:
fifth instructions for receiving, at the wireless device, service data from the telematic service provider;
sixth instructions for transmitting the service data to the telematic unit;
seventh instructions for processing the service data at the telematic unit to product processed service data; and
eighth instructions for transmitting the processed service data to an appropriate output device.

13. The computer program product as recited in claim 9, wherein collecting data from the vehicle comprises receiving user input.

14. The computer program product as recited in claim 12, wherein the appropriate output device comprises an onboard vehicle computer.

15. The computer program product as recited in claim 12, wherein the appropriate output device comprises a user output device.

16. The computer program product as recited in claim 15, wherein the user output device comprises at least one of a speaker and a video display terminal.

17. A system for providing telematic services for a vehicle, the system comprising:
first means for collecting vehicle data from the vehicle;
second means, responsive to a determination that a portable wireless device is not coupled to a telematic unit, for buffering the vehicle data in a memory until such time as a portable wireless device is coupled to the telematic unit; and
third means, responsive to a determination that a user's portable wireless device is coupled to a telematic unit, for transmitting the vehicle data from the telematic unit to the user's portable wireless device.

18. The system as recited in claim 17, wherein the portable wireless device comprises one of a wireless telephone, a personal digital assistant, and a portable data processing system.

19. The system as recited in claim 17, further comprising:
fourth means for transmitting, from the wireless device, the vehicle data received from the telematic unit to a telematic service provider.

20. The system as recited in claim 19, further comprising:
fifth means for receiving, at the wireless device, service data from the telematic service provider;
sixth means for transmitting the service data to the telematic unit;
seventh means for processing the service data at the telematic unit to product processed service data; and
eighth means for transmitting the processed service data to an appropriate output device.

21. The system as recited in claim 17, wherein collecting data from the vehicle comprises receiving user input.

22. The system as recited in claim 20, wherein the appropriate output device comprises an onboard vehicle computer.

23. The system as recited in claim 20, wherein the appropriate output device comprises a user output device.

24. The system as recited in claim 23, wherein the user output device comprises at least one of a speaker and a video display terminal.

25. A telematics unit, the unit comprising:
a data input/output unit for collecting and transmitting data to a vehicle's onboard computer;
a user input unit for receiving user input;
a wireless device interface for communicating with an external portable wireless device, wherein the external portable wireless device provides communication with a telematics service provider;
a processor for processing data received from the vehicle's onboard computer, the user, and the external portable wireless device.

26. The telematics unit as recited in claim 25, further comprising:
a memory for buffering data collected from the vehicle prior to sending the data to the external portable wireless device.

27. The telematics unit as recited in claim 25, further comprising:
a user output device for presenting information to the user.

28. The telematics unit as recited in claim 27, wherein the user output device comprises at least one of a speaker and a video display terminal.
